(19) United States
(12) Patent Application Publication
(10) Pub. No.: US 2025/0044566 A1
(43) Pub. Date: Feb. 6, 2025

(54) SCANNING MICROSCOPE

(71) Applicant: NIKON CORPORATION, Tokyo (JP)

(72) Inventors: Hidetsugu TAKAGI, Yokohama-shi (JP); Miwako YOSHIDA, Yokohama-shi (JP); Fumio SUZUKI, Yokohama-shi (JP)

(73) Assignee: NIKON CORPORATION, Tokyo (JP)

(21) Appl. No.: 18/716,380

(22) PCT Filed: Dec. 2, 2022
(86) PCT No.: PCT/JP2022/044549

§ 371 Date: Jun. 5, 2024

(30) Foreign Application Priority Data
Dec. 8, 2021 (JP) 2021-199649

(51) Int. Cl. G02B 21/00

(52) U.S. Cl. CPC G02B 21/0036; G02B 21/0032; G02B 21/0052

(57) ABSTRACT

A scanning optical system (SL) of this scanning microscope comprises a plurality of lens components and has positive refractive power as a whole, each lens component comprising one cemented lens composed of a plurality of lenses cemented to each other, or one lens. The scanning optical system satisfies the following conditional expression. 0.007<Σ(nd×tc/νd)/LA<0.021 where Σ(nd×tc/νd) is the sum total of nd×tc/νd of lenses of the plurality of lens components when a refractive index for the d line of a lens constituting the plurality of lens components is denoted by nd, the center thickness of the lens is denoted by tc, and the Abbe's number of the lens is denoted by νd, and LA is the distance on an optical axis from a lens surface on the scanning mechanism side of a lens component closest to a scanning mechanism to a lens surface on the objective optical system side of a lens component closest to an objective optical system.

### CROSS REFERENCE TO RELATED APPLICATIONS

This application is a U.S. National Stage Application which claims the benefit under 35 U.S.C. § 371 of International Patent Application No. PCT/JP2022/044549 filed on Dec. 2, 2022, which claims priority benefit from Japanese Patent Application No. 2021-199649 filed on Dec. 8, 2021, the contents of each of which are incorporated herein by reference.

### TECHNICAL FIELD

The present invention relates to a scanning microscope.

### TECHNICAL BACKGROUND

A scanning microscope that comprises a scanning optical system guiding light from a scanning mechanism to an objective optical system has been known (for example, see Patent literature 1). It is difficult to obtain a bright image by such a scanning microscope.

### PRIOR ARTS LIST

### Patent Document

Patent literature 1: Japanese Laid-Open Patent Publication No. 2017-102013(A)

### SUMMARY OF THE INVENTION

A scanning microscope according to the present invention comprises: a scanning mechanism configured to scan a sample with light from a light source; an objective optical system configured to collect light from the scanning mechanism to the sample; and a scanning optical system provided between the scanning mechanism and the objective optical system, and configured to guide the light from the scanning mechanism to the objective optical system, in which the scanning optical system comprises a plurality of lens components arranged along an optical axis, and has a positive refractive power as a whole, each of the lens components is one cemented lens in which a plurality of lenses are cemented with one another, or one lens, a lens surface on the scanning mechanism side of the lens component closest to the scanning mechanism among the plurality of lens components is a concave surface, a lens surface on the objective optical system side of the lens component closest to the objective optical system among the plurality of lens components is a concave surface, and the following conditional expression is satisfied:

$$0.007 < Σ ( nd \times tc / vd ) / LA < 0.021 ,$$

where Σ(nd×tc/νd) is: when a refractive index to d-line of each of lenses configuring the plurality of lens components is nd, a center thickness of each of the lenses is tc, and an Abbe number of each of the lenses is νd, a sum of nd×tc/νd of the lenses of the plurality of lens components, and
LA: a distance on the optical axis from the lens surface on the scanning mechanism side of the lens component closest to the scanning mechanism to the lens surface on the objective optical system side of the lens component closest to the objective optical system.

### BRIEF DESCRIPTION OF THE DRAWINGS

FIG. 1 is an explanatory view illustrating an example of a scanning microscope comprising a scanning optical system;

FIG. 2 is a cross-sectional view illustrating a configuration of a scanning optical system according to a first example;

FIG. 3 is a graph showing various aberrations of the scanning optical system according to the first example;

FIG. 4 is a graph showing chromatic aberration of the scanning optical system according to the first example;

FIG. 5 is a graph showing coma aberration of the scanning optical system according to the first example;

FIG. 6 is a cross-sectional view illustrating a configuration of a scanning optical system according to a second example;

FIG. 7 is a graph showing various aberrations of the scanning optical system according to the second example;

FIG. 8 is a graph showing chromatic aberration of the scanning optical system according to the second example;

FIG. 9 is a graph showing coma aberration of the scanning optical system according to the second example;

FIG. 10 is a cross-sectional view illustrating a configuration of a scanning optical system according to a third example;

FIG. 11 is a graph showing various aberrations of the scanning optical system according to the third example;

FIG. 12 is a graph showing chromatic aberration of the scanning optical system according to the third example;

FIG. 13 is a graph showing coma aberration of the scanning optical system according to the third example;

FIG. 14 is a cross-sectional view illustrating a configuration of a scanning optical system according to a fourth example;

FIG. 15 is a graph showing various aberrations of the scanning optical system according to the fourth example;

FIG. 16 is a graph showing chromatic aberration of the scanning optical system according to the fourth example; and

FIG. 17 is a graph showing coma aberration of the scanning optical system according to the fourth example.

### DESCRIPTION OF THE EMBODIMENTS

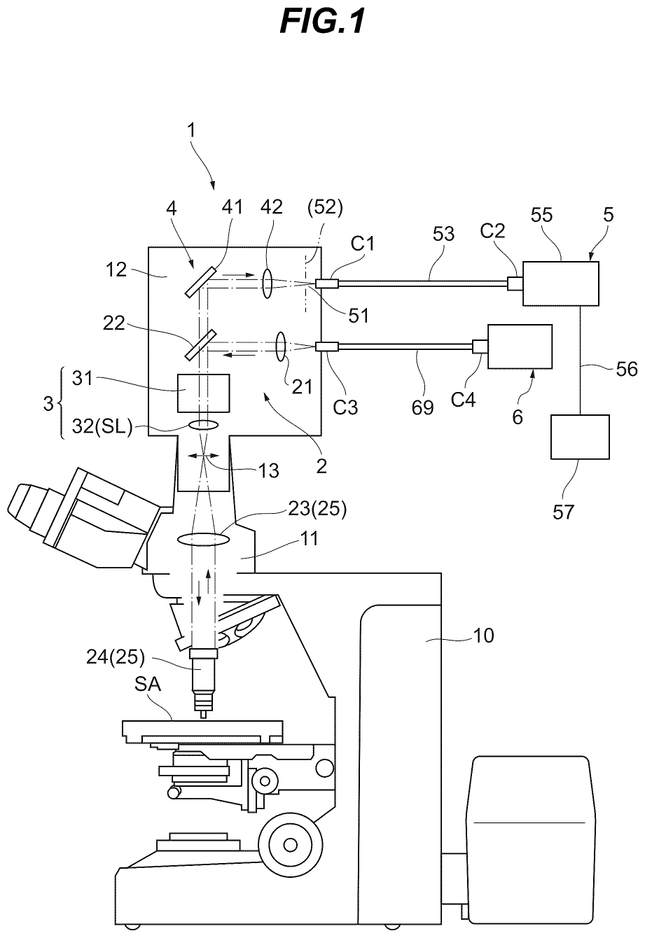

A scanning microscope comprising a scanning optical system according to a present embodiment is described below. First, a scanning confocal microscope 1 is described as an example of the scanning microscope according to the present embodiment with reference to FIG. 1. The scanning confocal microscope 1 comprises an excitation light introduction unit 2 guiding illumination laser light from a light source unit 6 onto a sample SA, a scanning device 3 deflecting the laser light collected on the sample SA and scanning the sample SA with the laser light, a light detection device 5 detecting a light intensity signal from the sample SA supporting multiphoton excitation, and a collective optical system 4 guiding light from the sample SA to the light detection device 5.

The light source unit 6 may be provided in the scanning confocal microscope 1, or may be provided separately from the scanning confocal microscope 1. The light source unit 6 comprises a laser light source (not illustrated), a beam diameter adjustment mechanism (not illustrated), and the like. The light source unit 6 oscillates pulsed laser light as the illumination laser light.

The excitation light introduction unit 2 comprises a collimator lens 21, a dichroic mirror 22, and an objective optical system 25 comprising a second objective lens 23 and an objective lens 24. The collimator lens 21 and the dichroic mirror 22 are disposed inside a microscope casing 12 provided above a lens barrel 11 of a microscope main body 10. The light source unit 6 and the microscope casing 12 are connected through an optical fiber 69 by using connectors C3 and C4. The collimator lens 21 converts the laser light (light flux) oscillated by the light source unit 6 into parallel light. The dichroic mirror 22 reflects the laser light from the collimator lens 21 toward the sample SA. The objective optical system 25 collects the laser light reflected by the dichroic mirror 22 onto the sample SA by the second objective lens 23 and the objective lens 24. The second objective lens 23 is disposed inside the lens barrel 11 of the microscope main body 10. The objective lens 24 is attached to a lower part of the lens barrel 11.

The scanning device 3 comprises a scanning mechanism (scanner) 31 and a scanning optical system 32. The scanning device 3 is disposed between the dichroic mirror 22 and the second objective lens 23 inside the microscope casing 12. The scanning mechanism (scanner) 31 comprises, for example, a galvanometer mirror (not illustrated) or a resonant mirror (not illustrated). The scanning mechanism (scanner) 31 deflects incident laser light. In other words, the scanning mechanism (scanner) 31 deflects the laser light collected onto the sample SA, and scans the sample SA with the laser light. The scanning optical system 32 is an optical system provided between the scanning mechanism (scanner) 31 and the second objective lens 23. The scanning optical system 32 is also an optical system having a focal position that is positioned on an imaging surface 13 (also referred to as primary image surface) conjugate with the sample SA (scanning surface of sample SA).

The collective optical system 4 comprises the objective lens 24 and the second objective lens 23 configuring the objective optical system 25, a total reflection mirror 41, and a collective lens 42. The total reflection mirror 41 and the collective lens 42 are disposed above the dichroic mirror 22 inside the microscope casing 12. The total reflection mirror 41 reflects fluorescent light from the sample SA having passed through the objective lens 24 and the second objective lens 23. The collective lens 42 collects the fluorescent light reflected by the total reflection mirror 41.

The light detection device 5 comprises an optical fiber 53 and a detection unit 55. The optical fiber 53 is connected to the microscope casing 12 and the detection unit 55 by using connectors C1 and C2. The light (fluorescent light) collected by the collective lens 42 enters the optical fiber 53. The detection unit 55 detects light (fluorescent light) having passed through the optical fiber 53. A processing unit 57 is electrically connected to the detection unit 55 through a cable 56. The processing unit 57 performs image processing (of sample SA) based on a detection signal detected by the detection unit 55, and an observation image of the sample SA obtained by the image processing of the processing unit 57 is displayed on an unillustrated monitor.

The laser light from the scanning device 3 is once collected on the imaging surface 13 (primary image surface), and is again collected onto the sample SA by the second objective lens 23 and the objective lens 24 of the objective optical system 25. In other words, the scanning surface of the sample SA, the imaging surface 13, and a light incident surface to the optical fiber 53 have conjugate relationship. Therefore, the light is collected onto the sample SA by the second objective lens 23 and the objective lens 24, which makes it possible to cause the fluorescent light passing through the objective lens 24 out of the fluorescent light generated by multiphoton excitation, to reach the detection unit 55 without omission. In addition, in a case of the multiphoton excitation confocal microscope, multiphoton excitation occurs only in a minute region near a focal point of the objective lens 24. Therefore, as with a normal confocal microscope, an image near a focal plane of the objective lens 24 can be obtained without using a shielding plate 52 (see alternate long and two short dashes line in FIG. 1) having a pinhole.

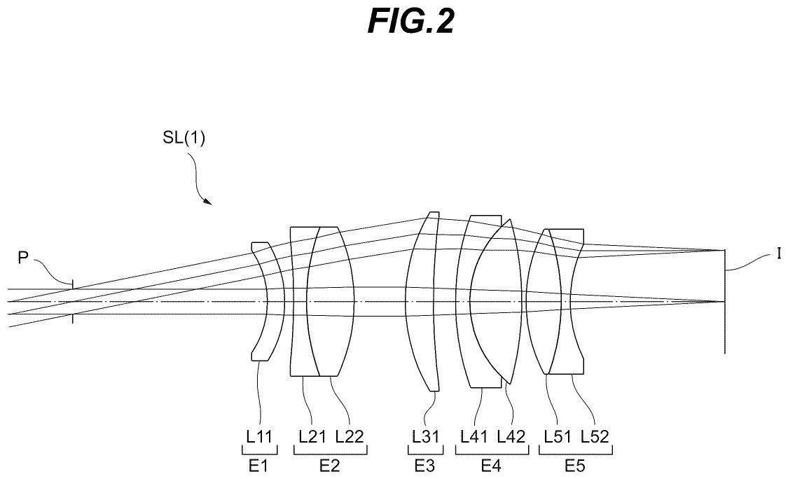

As the scanning optical system 32, a scanning optical system SL described below can be used. Therefore, the scanning optical system SL used for the scanning microscope (scanning confocal microscope 1) according to the present embodiment is described. The scanning optical system SL according to the present embodiment comprises a plurality of lens components arranged along an optical axis, for example, as with a scanning optical system SL(1) illustrated in FIG. 2, and has a positive refractive power as a whole. Each of the lens components comprises one cemented lens in which a plurality of lenses are cemented with one another, or one lens. A lens surface on the scanning mechanism side of the lens component closest to the scanning mechanism 31 (pupil conjugate surface P conjugate with pupil surface of objective optical system 25) among the plurality of lens components is a concave surface. A lens surface on the objective optical system side of the lens component closest to the objective optical system 25 (image surface I) among the plurality of lens components is a concave surface.

In this configuration, the scanning optical system SL according to the present embodiment satisfies the following conditional expression (1),

$$0.007 < Σ ( nd \times tc / vd ) / LA < 0.021 \qquad ( 1 )$$

where Σ(nd×tc/νd) is: when a refractive index to d-line of each of lenses configuring the plurality of lens components is nd, a center thickness of each of the lenses is tc, and an Abbe number of each of the lenses is νd, a sum of nd×tc/νd of the lenses of the plurality of lens components, and
LA: a distance on the optical axis from the lens surface on the scanning mechanism side of the lens component closest to the scanning mechanism 31 to the lens surface on the objective optical system side of the lens component closest to the objective optical system 25.

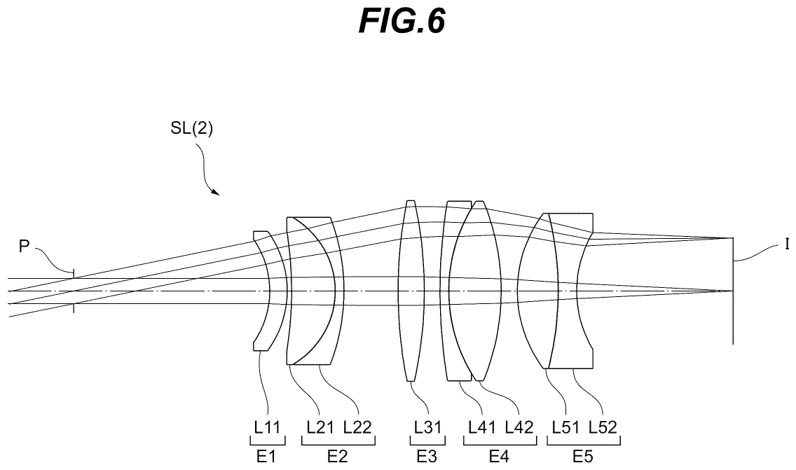

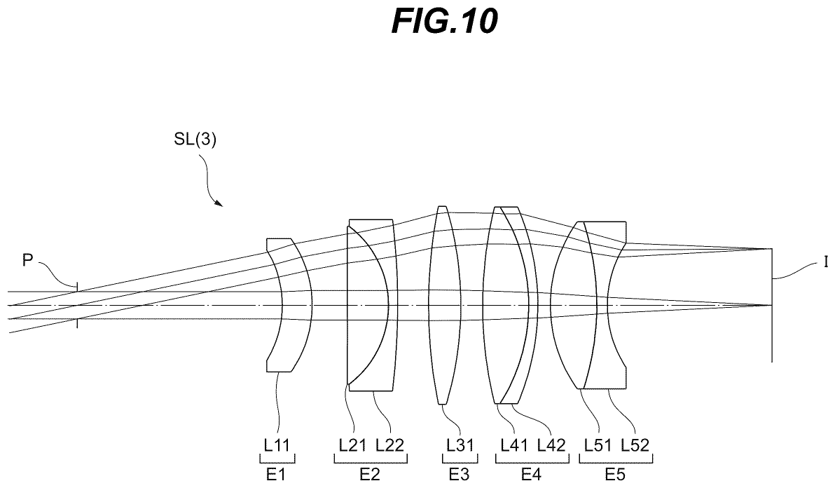

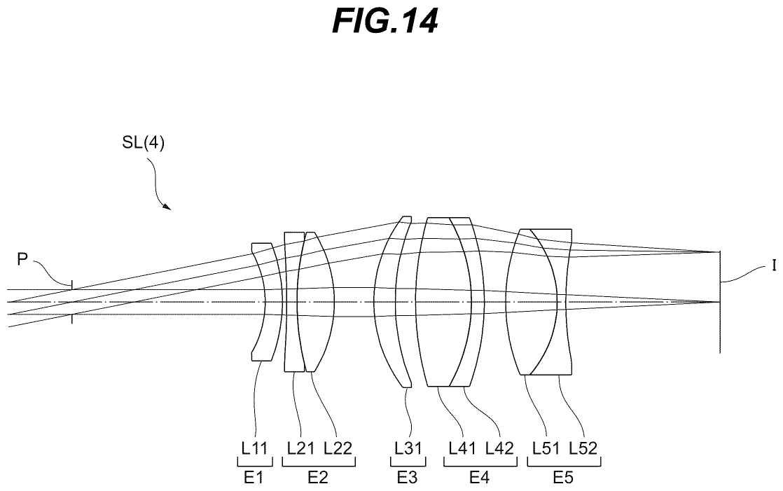

According to the present embodiment, the lens surfaces on both ends of the scanning optical system SL are formed in symmetrical shapes, which makes it possible to sufficiently correct curvature of field and astigmatism, and to obtain a bright image. The scanning optical system SL according to the present embodiment may be a scanning optical system SL(2) illustrated in FIG. 6, a scanning optical system SL(3) illustrated in FIG. 10, or a scanning optical system SL(4) illustrated in FIG. 14.

The conditional expression (1) defines appropriate relationship between the sum of nd×tc/νd of the lenses of the plurality of lens components and the distance on the optical axis from the lens surface on the scanning mechanism side of the lens component closest to the scanning mechanism 31 to the lens surface on the objective optical system side of the lens component closest to the objective optical system 25. Note that the center thickness (tc) of the lens is a distance on the optical axis from the lens surface on the scanning mechanism side of the lens to the lens surface on the objective optical system side of the lens.

As an observation method of a microscope that can obtain a nonlinear optical effect at a portion where photon density is high during observation of fluorescent light, an observation method of a two-photon excitation microscope (also referred to as multiphoton excitation microscope) is known. As described above, the multiphoton excitation microscope is configured using a scanning confocal microscope. To cause multiphoton excitation with high excitation efficiency in the multiphoton excitation microscope, it is necessary to instantaneously enhance the photon density by using pulsed laser light as excitation light. The light pulse of the excitation light preferably has a sharp waveform having an extremely narrow pulse width. However, when the light pulse propagates through a medium (e.g., lens) having group velocity dispersion, the pulse width (time width) of the light pulse is increased.

The group velocity dispersion (GVD) is a phenomenon in which the group velocity (propagation velocity of bulk wave) is changed depending on a wavelength. When the wavelength of the light is λ, the velocity of the light is c, and the refractive index of the medium is n(λ), the group velocity dispersion GVD is represented by the following expression (A).

$$GVD = \frac{{λ}^{2}}{2 π {c}^{2}} \frac{{d}^{2} - n ( λ )}{d {λ}^{2}} [ {fs}^{2} / mm ] \qquad ( A )$$

The expression (A) of the group velocity dispersion GVD can be determined based on an expression of a propagation constant k and a frequency co of the light. The expression of a second-order component k₂ determined from the propagation constant k, namely, the group velocity dispersion GVD and the frequency ω of the light is represented by the following expression (B) (about details of propagation constant k, see Robert W. Boyd, “Nonlinear Optics Second Edition” (ISBN: 0-12-121682-9), pp. 358-360).

$${k}_{2} = {( \frac{{d}^{2} k}{d {ω}^{2}} )}_{ω = {ω}_{o}} \qquad ( B )$$

A value obtained by multiplying the group velocity dispersion GVD by the center thickness of the lens is referred to as group delay dispersion (GDD). When the group delay dispersion GDD is increased, the pulse width (time width) of the light pulse is increased, and the excitation efficiency of the multiphoton excitation is reduced. Therefore, in the existing multiphoton excitation microscope, it is difficult to cause multiphoton excitation with high excitation efficiency and to obtain a bright image.

In the present embodiment, since the sum of the center thicknesses of the lenses is reduced by satisfying the conditional expression (1), an optical path length of the light passing through the lenses is reduced, and the group delay dispersion GDD can be reduced. Further, since a reciprocal of the Abbe number, namely, a sum of the values indicating dispersion is reduced by satisfying the conditional expression (1), the dispersion of the medium (lenses) on the optical path is reduced, and the group delay dispersion GDD can be reduced. As described above, since the group delay dispersion GDD can be reduced by satisfying the conditional expression (1), it is possible to cause multiphoton excitation with high excitation efficiency, and to obtain a bright image.

When a corresponding value of the conditional expression (1) exceeds an upper limit value, the sum of the center thicknesses of the lenses is increased, and the optical path length of the light passing through the lenses is accordingly increased. As a result, the group delay dispersion GDD is increased, which makes it difficult to cause multiphoton excitation with high excitation efficiency, and to obtain a bright image. By setting the upper limit value of the conditional expression (1) to 0.02 or 0.018, the effects by the present embodiment can be more surely achieved.

When the corresponding value of the conditional expression (1) is less than a lower limit value, the sum of the center thicknesses of the lenses becomes excessively small, which makes it difficult to correct aberrations such as curvature of field and astigmatism. By setting the lower limit value of the conditional expression (1) to 0.01, 0.013, or 0.015, the effects by the present embodiment can be more surely achieved.

The scanning optical system SL according to the present embodiment may satisfy the following conditional expression (2) and the following conditional expression (3),

$$- 3 < ( ndA - 1 ) / rA \times f < - 0.6 \qquad ( 2 )$$

$$0.5 ( ndE - 1 ) / rE \times f < 3 \qquad ( 3 )$$

where ndA: a refractive index to d-line of the lens closest to the scanning mechanism 31 among the lenses configuring the plurality of lens components,
rA: a radius of curvature of the lens surface on the scanning mechanism side of the lens closest to the scanning mechanism 31,
ndE: a refractive index to d-line of the lens closest to the objective optical system 25 among the lenses configuring the plurality of lens components,
rE: a radius of curvature of the lens surface on the objective optical system side of the lens closest to the objective optical system 25, and
f: a focal length of the scanning optical system SL.

The conditional expression (2) defines appropriate relationship of the refractive index to d-line of the lens closest to the scanning mechanism 31 among the lenses configuring the plurality of lens components, the radius of curvature of the lens surface on the scanning mechanism side of the lens closest to the scanning mechanism 31, and the focal length of the scanning optical system SL. The conditional expression (3) defines appropriate relationship of the refractive index to d-line of the lens closest to the objective optical system 25 among the lenses configuring the plurality of lens components, the radius of curvature of the lens surface on the objective optical system side, of the lens closest to the objective optical system 25, and the focal length of the scanning optical system SL. The radius of curvature of the lens surface has a positive value in a case where a curvature center is positioned on the objective optical system side (image surface side). By satisfying the conditional expression (2) and the conditional expression (3), it is possible to form the lens surfaces on both ends of the scanning optical system SL in symmetrical shapes, and to sufficiently correct curvature of field and astigmatism.

When a corresponding value of the conditional expression (2) is out of the above-described range, it is difficult to form the lens surfaces on both ends of the scanning optical system SL in symmetrical shapes, and to correct curvature of field and astigmatism. By setting an upper limit value of the conditional expression (2) to −0.8, −1, or −1.2, the effects by the present embodiment can be more surely achieved. By setting a lower limit value of the conditional expression (2) to −2.5, −2, or −1.5, the effects by the present embodiment can be more surely achieved.

When a corresponding value of the conditional expression (3) is out of the above-described range, it is difficult to form the lens surfaces on both ends of the scanning optical system SL in symmetrical shapes, and to correct curvature of field and astigmatism. By setting an upper limit value of the conditional expression (3) to 2.5, 2, or 1.8, the effects by the present embodiment can be more surely achieved. By setting a lower limit value of the conditional expression (3) to 0.54, 0.8, 1, or 1.2, the effects by the present embodiment can be more surely achieved.

In the scanning optical system SL according to the present embodiment, a part of the plurality of lens components may comprise one positive lens, and may satisfy the following conditional expression (4) and the following conditional expression (5),

$$vdP < 38 \qquad ( 4 )$$

$$0.651 < θ gFP + ( 0.001682 \times vdP ) \qquad ( 5 )$$

where νdP: an Abbe number of the positive lens, and
θgFP: a partial dispersion ratio of the positive lens, and is defined by the following expression when a refractive index to g-line of the positive lens is ngP, a refractive index to F-line of the positive lens is nFP, and a refractive index to C-line of the positive lens is nCP,

$$θ gFP = ( ngP - nFP ) / ( nFP - nCP ) .$$

The conditional expression (4) defines an appropriate range of the Abbe number of the positive lens. The conditional expression (5) defines appropriate relationship between the partial dispersion ratio of the positive lens and the Abbe number of the positive lens. By satisfying the conditional expression (4) and the conditional expression (5), it is possible to sufficiently correct secondary spectrums in addition to primary achromatism in a wide wavelength range, in correction of chromatic aberration of magnification and longitudinal chromatic aberration.

When a corresponding value of the conditional expression (4) exceeds an upper limit value, it is difficult to correct secondary spectrums of chromatic aberration of magnification and longitudinal chromatic aberration. By setting the upper limit value of the conditional expression (4) to 37 or 36, the effects by the present embodiment can be more surely achieved.

When a corresponding value of the conditional expression (5) is less than a lower limit value, it is difficult to correct secondary spectrums of chromatic aberration of magnification and longitudinal chromatic aberration. By setting the lower limit value of the conditional expression (5) to 0.652, the effects by the present embodiment can be more surely achieved. Further, by setting the lower limit value of the conditional expression (5) to 0.85, 0.8, 0.75, or less than 0.7, the effects by the present embodiment can be more surely achieved.

The scanning optical system SL according to the present embodiment may satisfy the following conditional expression (6),

$$1 < fp / f < 5 \qquad ( 6 )$$

where fP: a focal length of the positive lens, and
f: the focal length of the scanning optical system SL.

The conditional expression (6) defines appropriate relationship between the focal length of the positive lens and the focal length of the scanning optical system SL. By satisfying the conditional expression (6), the focal length of the positive lens is increased, and therefore the radius of curvature of the lens surface of the positive lens is increased and the center thickness of the positive lens can be reduced. As a result, the optical path length of the light passing through the positive lens is reduced, and the group delay dispersion GDD can be reduced, which makes it possible to cause multiphoton excitation with high excitation efficiency and to obtain a bright image.

When a corresponding value of the conditional expression (6) exceeds an upper limit value, the focal length of the scanning optical system SL is reduced, and therefore the radius of curvature of the lens surface of each of the lenses other than the above-described positive lens tends to be reduced, and it is difficult to reduce the center thicknesses of the lenses. As a result, the optical path length of the light passing through the lenses is increased, and the group delay dispersion GDD is increased, which makes it difficult to cause multiphoton excitation with high excitation efficiency and to obtain a bright image. By setting the upper limit value of the conditional expression (6) to 4.5, 4.0, or 3.0, the effects by the present embodiment can be more surely achieved.

When the corresponding value of the conditional expression (6) is less than a lower limit value, the focal length of the positive lens is reduced, and therefore the radius of curvature of the lens surface of the positive lens is reduced, and it is difficult to reduce the center thickness of the positive lens. As a result, the optical path length of the light passing through the positive lens is increased, and the group delay dispersion (GDD) is increased, which makes it difficult to cause multiphoton excitation with high excitation efficiency, and to obtain a bright image. By setting the lower limit value of the conditional expression (6) to 1.1, 1.2, or 1.25, the effects by the present embodiment can be more surely achieved.

The scanning optical system SL according to the present embodiment may satisfy the following conditional expression (7),

$$0. 7 < D 0 / f < 1 \qquad ( 7 )$$

where D0: an interval on the optical axis between the scanning mechanism 31 and the lens component closest to the scanning mechanism 31, and
f: the focal length of the scanning optical system SL.

The conditional expression (7) defines appropriate relationship between the interval on the optical axis between the scanning mechanism 31 and the lens component closest to the scanning mechanism 31 and the focal length of the scanning optical system SL. By satisfying the conditional expression (7), the interval on the optical axis between the scanning mechanism 31 and the lens component closest to the scanning mechanism 31 is increased, which makes it possible to easily incorporate a part holding the scanning mechanism 31 and a part driving the scanning mechanism 31.

When a corresponding value of the conditional expression (7) exceeds an upper limit value, the focal length of the scanning optical system SL is reduced, and therefore the radius of curvature of the lens surface of each of the lenses tends to be reduced, and it is difficult to reduce the center thicknesses of the lenses. As a result, the optical path length of the light passing through the lenses is increased, and the group delay dispersion GDD is increased, which makes it difficult to cause multiphoton excitation with high excitation efficiency and to obtain a bright image. By setting the upper limit value of the conditional expression (7) to 0.95, 0.9, 0.8, or 0.75, the effects by the present embodiment can be more surely achieved.

When the corresponding value of the conditional expression (7) is less than a lower limit value, the interval on the optical axis between the scanning mechanism 31 and the lens component closest to the scanning mechanism 31 is reduced, and therefore it is difficult to incorporate the part holding the scanning mechanism 31 and the part driving the scanning mechanism 31. By setting the lower limit value of the conditional expression (7) to 0.72, the effects by the present embodiment can be more surely achieved.

The scanning optical system SL according to the present embodiment may satisfy the following conditional expression (8),

$$0.5 < ( \sum tc ) / LA < 0.9 \qquad ( 8 )$$

where Σtc: a sum of tc of the lenses of the plurality of lens components.

The conditional expression (8) defines appropriate relationship between the sum of the center thicknesses (tc) of the lenses of the plurality of lens components and the distance on the optical axis from the lens surface on the scanning mechanism side of the lens component closest to the scanning mechanism 31 to the lens surface on the objective optical system side of the lens component closest to the objective optical system 25. By satisfying the conditional expression (8), the sum of the center thicknesses of the lenses is reduced, and therefore the optical path length of the light passing through the lenses is reduced. As a result, the group delay dispersion GDD can be reduced, which makes it possible to cause multiphoton excitation with high excitation efficiency and to obtain a bright image.

When a corresponding value of the conditional expression (8) exceeds an upper limit value, the sum of the center thicknesses of the lenses is increased, and therefore the optical path length of the light passing through the lenses is increased. As a result, the group delay dispersion GDD is increased, which makes it difficult to cause multiphoton excitation with high excitation efficiency and to obtain a bright image. By setting the upper limit value of the conditional expression (8) to 0.85, 0.8 or 0.75, the effects by the present embodiment can be more surely achieved.

When the corresponding value of the conditional expression (8) is less than a lower limit value, the sum of the center thicknesses of the lenses becomes excessively small, which makes it difficult to correct aberrations such as curvature of field and astigmatism. By setting the lower limit value of the conditional expression (8) to 0.6 or 0.65, the effects by the present embodiment can be more surely achieved.

In the scanning optical system SL according to the present embodiment, the plurality of lens components may comprise a first lens component, a second lens component, a third lens component, and a fourth lens component arranged in order from the scanning mechanism 31 (pupil conjugate surface P) side along the optical axis, and may satisfy the following conditional expressions (9) to (11),

$$0 < D 3 / D 2 < 1 \qquad ( 9 )$$

$$0.04 < D 2 / TL < 0 \text{.11} \qquad ( 10 )$$

$$0.02 < D 3 / TL < 0 \text{.05} \qquad ( 11 )$$

where D2: an air distance on the optical axis between the second lens component and the third lens component,
D3: an air distance on the optical axis between the third lens component and the fourth lens component, and
TL: a distance on the optical axis between the pupil conjugate surface P disposed on the scanning mechanism side of the scanning optical system SL and the image surface I disposed on the objective optical system side of the scanning optical system SL.

The conditional expression (9) defines appropriate relationship between the air distance on the optical axis between the third lens component and the fourth lens component and the air distance on the optical axis between the second lens component and the third lens component. The conditional expression (10) defines appropriate relationship between the air distance on the optical axis between the second lens component and the third lens component and an entire length of the scanning optical system SL, namely, the distance on the optical axis between the pupil conjugate surface P disposed on the scanning mechanism side of the scanning optical system SL and the image surface I (imaging surface 13) disposed on the objective optical system side of the scanning optical system SL. The conditional expression (12) defines appropriate relationship between the air distance on the optical axis between the third lens component and the fourth lens component and the distance on the optical axis between the pupil conjugate surface P disposed on the scanning mechanism side of the scanning optical system SL and the image surface I (imaging surface 13) disposed on the objective optical system side of the scanning optical system SL. By satisfying the conditional expressions (9) to (11), the scanning optical system SL can be brought close to a telecentric condition relative to the imaging surface 13 (primary image surface), which makes it possible to sufficiently correct astigmatism.

When a corresponding value of the conditional expression (9) is out of the above-described range, the scanning optical system SL cannot be brought close to the telecentric condition, which makes it difficult to correct astigmatism. By setting the upper limit value of the conditional expression (9) to 0.9, 0.8, or 0.75, the effects by the present embodiment can be more surely achieved. By setting a lower limit value of the conditional expression (9) to 0.1, 0.2, or 0.25, the effects by the present embodiment can be more surely achieved.

When a corresponding value of the conditional expression (10) is out of the above-described range, the scanning optical system SL cannot be brought close to the telecentric condition, which makes it difficult to correct astigmatism. By setting an upper limit value of the conditional expression (10) to 0.1 or 0.09, the effects by the present embodiment can be more surely achieved. By setting a lower limit value of the conditional expression (10) to 0.044, the effects by the present embodiment can be more surely achieved.

When a corresponding value of the conditional expression (11) is out of the above-described range, the scanning optical system SL cannot be brought close to the telecentric condition, which makes it difficult to correct astigmatism. By setting an upper limit value of the conditional expression (11) to 0.04, the effects by the present embodiment can be more surely achieved. By setting a lower limit value of the conditional expression (11) to 0.023, the effects by the present embodiment can be more surely achieved.

The scanning optical system SL according to the present embodiment may satisfy the following conditional expression (12),

$$0. 0002 \; 14 < \sum ( nd \times tc / {vd}^{2} ) / LA < 0.000429 \qquad ( 12 )$$

where Σ(nd×tc/νd²): a sum of nd×tc/νd² of the lenses of the plurality of lens components.

The conditional expression (12) defines appropriate relationship between the sum of nd×tc/νd² of the lenses of the plurality of lens components and the distance on the optical axis from the lens surface of the scanning mechanism side of the lens component closest to the scanning mechanism 31 to the lens surface on the objective optical system side of the lens component closest to the objective optical system 25. By satisfying the conditional expression (12), the sum of the center thicknesses of the lenses is reduced, and therefore the optical path length of the light passing through the lenses is reduced, and the group delay dispersion GDD can be reduced. Further, by satisfying the conditional expression (12), a reciprocal of a square of the Abbe number, namely, the sum of a square of the value indicating dispersion is reduced, and therefore dispersion of the medium (lens) on the optical path is reduced, and the group delay dispersion GDD can be reduced. As described above, by satisfying the conditional expression (12), the group delay dispersion GDD can be reduced, which makes it possible to cause multiphoton excitation with high excitation efficiency and to obtain a bright image.

When a corresponding value of the conditional expression (12) exceeds an upper limit value, the sum of the center thicknesses of the lenses is increased, and therefore the optical path length of the light passing through the lens is increased. As a result, the group delay dispersion GDD is increased, which makes it difficult to cause multiphoton excitation with high excitation efficiency and to obtain a bright image. By setting the upper limit value of the conditional expression (12) to 0.0004, 0.00035, or 0.00033, the effects by the present embodiment can be more surely achieved.

When the corresponding value of the conditional expression (12) is less than a lower limit value, the sum of the center thicknesses of the lenses becomes excessively small, which makes it difficult to correct aberrations such as curvature of field and astigmatism. By setting the lower limit value of the conditional expression (12) to 0.00025 or 0.00028, the effects by the present embodiment can be more surely achieved.

### Examples

Examples of the scanning optical system SL provided in the scanning microscope according to the present embodiment are described below with reference to drawings. FIG. 2, FIG. 6, FIG. 10, and FIG. 14 are cross-sectional views illustrating configurations and refractive power distributions of the scanning optical systems SL {SL(1) to SL(4)} according to first to fourth examples. In FIG. 2, FIG. 6, FIG. 10, and FIG. 14, each lens component is represented by a combination of a symbol E and a numeral, and each lens is represented by a combination of a symbol L and a numeral. In this case, to prevent the types and numbers of symbols and numerals from being increased and complicated, the lens components and the like are represented using combinations of symbols and numerals independently in each of the examples. Therefore, even when the same combinations of symbols and numerals are used among the examples, the combinations do not mean the same configurations.

Among Table 1 to Table 4 illustrated below, Table 1 is a table showing various data in the first example, Table 2 is a table showing various data in the second example, Table 3 is a table showing various data in the third example, and Table 4 is a table showing various data in the fourth example. In each of the examples, as calculation targets of aberration characteristics, d-line (wavelength λ=587.6 nm), C-line (wavelength λ=656.3 nm), F-line (wavelength λ=486.1 nm), and g-line (wavelength λ=435.8 nm) are selected.

In a table of [General Data], f indicates the focal length of the scanning optical system. (D indicates a pupil diameter. FNO indicates F-number of the scanning optical system. Y indicates the maximum image height of the scanning optical system. TL indicates the entire length of the scanning optical system (distance on optical axis between pupil conjugate surface disposed on scanning mechanism side of scanning optical system and image surface disposed on objective optical system side of scanning optical system).

In a table of [Lens Data], a surface number indicates an order of optical surfaces from the pupil conjugate surface (scanning mechanism) side along a traveling direction of a light ray. R indicates a radius of curvature of each of the optical surfaces (surface having center of curvature positioned on image surface side is assumed to have positive value). D indicates a surface distance that is a distance on the optical axis from each of the optical surfaces to next optical surface (or image surface). νd indicates the Abbe number with d-line of a material of an optical member as a reference. nd indicates a refractive index to d-line of the material of the optical member. θgF indicates a partial dispersion ratio of the material of the optical member. The radius of curvature of “∞” indicates a plane or an aperture. Description of the refractive index nd=1.00000 of air is omitted.

The refractive index to g-line (wavelength λ=435.8 nm) of the material of the optical member is denoted by ng, the refractive index to F-line (wavelength λ=486.1 nm) of the material of the optical member is denoted by nF, and the refractive index to C-line (wavelength λ=656.3 nm) of the material of the optical member is denoted by nC. At this time, the partial dispersion ratio θgF of the material of the optical member is defined by the following expression (C).

$$θ gF = ( ng - nF ) / ( nF - nC ) \qquad ( C )$$

A table of [Lens Component Data] shows a starting surface (surface closest to object) and the focal length of each of the lens components.

In the following, among all data values, “mm” is generally used for the listed focal length f, radius of curvature R, surface distance D, other lengths, and the like unless otherwise noted; however, this is not limitative because equivalent optical performance can be achieved even when the optical system is proportionally enlarged or reduced.

The description of the table so far is common to all the examples, and repetitive description is omitted hereinafter.

### First Example

The first example is described with reference to FIG. 2 to FIG. 5 and Table 1. FIG. 2 is a cross-sectional view illustrating a configuration of a scanning optical system according to the first example. The scanning optical system SL(1) according to the first example comprises a first lens component E1 having a negative refractive power, a second lens component E2 having a positive refractive power, a third lens component E3 having a positive refractive power, a fourth lens component E4 having a positive refractive power, and a fifth lens component E5 having a negative refractive power, arranged in order from the pupil conjugate surface P side along the optical axis. The above-described scanning mechanism 31 (galvanometer mirror, etc.) is disposed near the pupil conjugate surface P conjugate with the pupil surface of the objective optical system 25 (objective lens 24). The image surface I corresponds to the above-described imaging surface 13. This is true of all the examples described below.

The first lens component E1 comprises a negative meniscus lens L11 having a concave surface facing the object. The second lens component E2 comprises a cemented lens having a positive refractive power in which a biconcave negative lens L21 and a biconvex positive lens L22 are cemented in order from the object side. The third lens component E3 comprises a positive meniscus lens L31 having a convex surface facing the object. The fourth lens component E4 comprises a cemented lens having a positive refractive power in which a negative meniscus lens L41 having a convex surface facing the object and a biconvex positive lens L42 are cemented in order from the object side. The fifth lens component E5 comprises a cemented lens having a negative refractive power in which a biconvex positive lens L51 and a biconcave negative lens L52 are cemented in order from the object side. The image surface I is arranged on the objective optical system side of the fifth lens component E5.

Table 1 described below lists values of data on the scanning optical system according to the first example. The first surface is the pupil conjugate surface P.

TABLE 1
[General Data]

| | | | |
|---|---|---|---|
| f = | 60.007 | Φ = | 6.000 |
| FNO = | 10.001 | Y = | 12.5 |
| TL = | 150.755 | | |

[Lens Data]

| Surface | | | | | |
|---|---|---|---|---|---|
| Number | R | D | νd | nd | θgF |
| 1 | ∞ | 45.000 | | | |
| 2 | −22.423 | 4.000 | 1.51680 | 64.13 | |
| 3 | −27.741 | 2.050 | | | |
| 4 | −148.175 | 3.000 | 1.61340 | 44.27 | |
| 5 | 52.693 | 11.000 | 1.45600 | 91.37 | |
| 6 | −43.165 | 11.850 | | | |
| 7 | 43.305 | 6.500 | 1.59270 | 35.31 | 0.59330 |
| 8 | 164.546 | 5.100 | | | |
| 9 | 62.465 | 3.300 | 1.71999 | 50.27 | |
| 10 | 25.694 | 12.000 | 1.49782 | 82.57 | |
| 11 | −74.529 | 1.000 | | | |
| 12 | 38.062 | 8.100 | 1.49782 | 82.57 | |
| 13 | −52.973 | 2.100 | 1.71700 | 47.97 | |
| 14 | 31.944 | 35.755 | | | |

[Lens Component Data]

| Lens Component | First surface | Focal length |
|---|---|---|
| E1 | 2 | −304.2894 |
| E2 | 4 | 245.926 |
| E3 | 7 | 97.2227 |
| E4 | 9 | 105.951 |
| E5 | 12 | −87.952 |

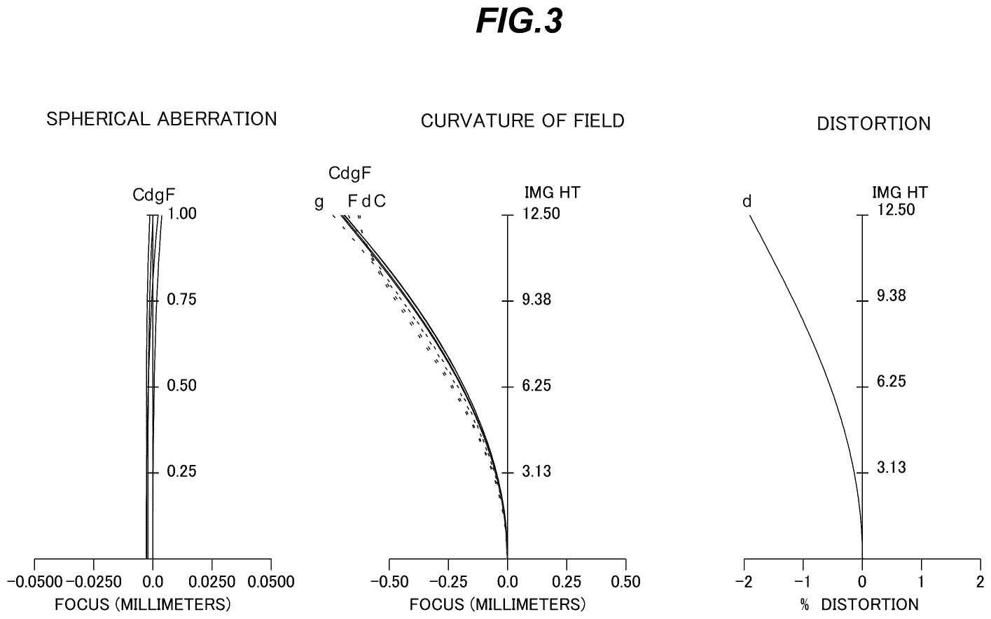

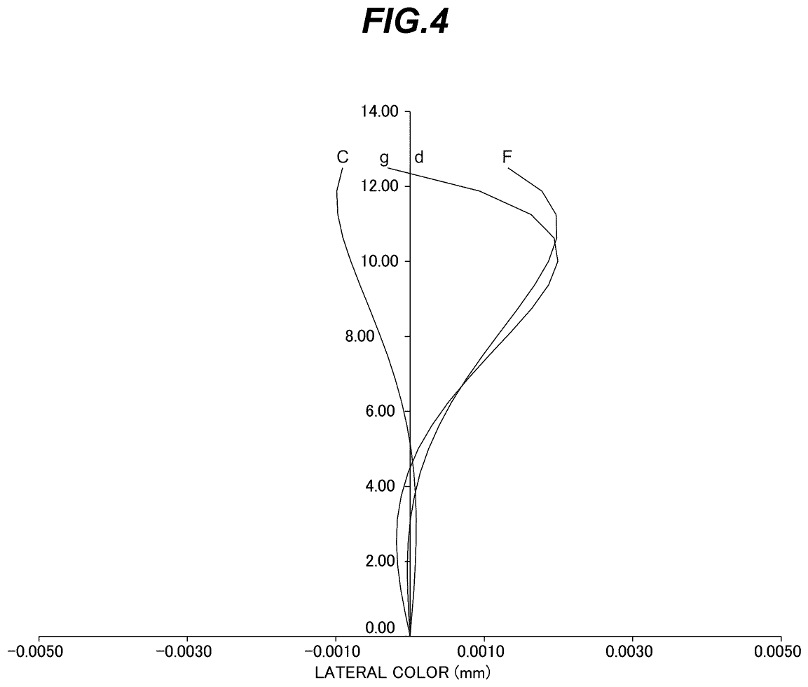

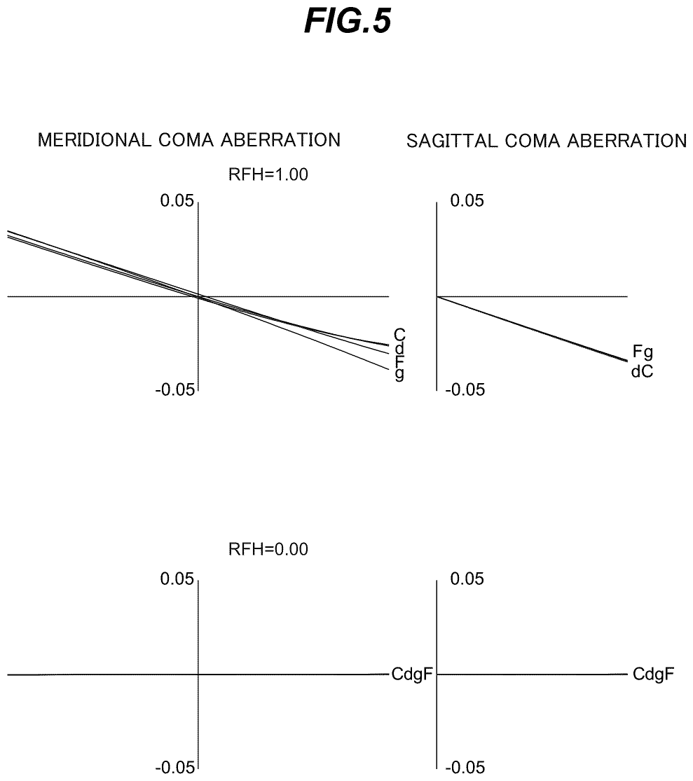

FIG. 3 is a graph showing various aberrations (spherical aberration, curvature of field, and distortion) of the scanning optical system according to the first example. FIG. 4 is a graph showing chromatic aberration of magnification (lateral chromatic aberration) of the scanning optical system according to the first example. FIG. 5 is a graph showing coma aberration (meridional coma aberration and sagittal coma aberration) of the scanning optical system according to the first example. In the graphs showing the aberrations in FIG. 3 to FIG. 5, d indicates various aberrations at d-line (wavelength λ=587.6 nm), C indicates various aberrations at C-line (wavelength λ=656.3 nm), F indicates various aberrations at F-line (wavelength λ=486.1 nm), and g indicates various aberrations at g-line (wavelength λ=435.8 nm). In the spherical aberration graph, a vertical axis indicates a value standardized while the maximum value of an entrance pupil radius is 1, and a lateral axis indicates a value [mm] of the aberration in each light ray. In the aberration graph showing curvature of field, a solid line indicates a meridional image surface to each wavelength, and a broken line indicates a sagittal image surface to each wavelength. In the aberration graph showing curvature of field, a vertical axis indicates an image height [mm], and a lateral axis indicates a value [mm] of the aberration. In the distortion graph, a vertical axis indicates an image height [mm], and a lateral axis indicates a ratio of the aberration as a percentage (%). In the aberration graph showing chromatic aberration of magnification, a vertical axis indicates an image height [mm], and a lateral axis indicates a value [mm] of the aberration. Each coma aberration graph indicates a value of the aberration when a relative field height RFH is 0.00 and 1.00. In the aberration graphs according to the examples described below, reference numerals similar to the reference numerals according to the present example are used, and repetitive description is omitted.

It is found from the aberration graphs that the scanning optical system according to the first example is sufficiently corrected in various aberrations such as curvature of field, and has excellent optical performance.

### Second Example

The second example is described with reference to FIG. 6 to FIG. 9 and Table 2. FIG. 6 is a cross-sectional view illustrating a configuration of a scanning optical system according to the second example. The scanning optical system SL(2) according to the second example comprises a first lens component E1 having a negative refractive power, a second lens component E2 having a positive refractive power, a third lens component E3 having a positive refractive power, a fourth lens component E4 having a positive refractive power, and a fifth lens component E5 having a negative refractive power, arranged in order from the pupil conjugate surface P side along the optical axis.

The first lens component E1 comprises a negative meniscus lens L11 having a concave surface facing the object. The second lens component E2 comprises a cemented lens having a positive refractive power in which a positive meniscus lens L21 having a concave surface facing the object and a negative meniscus lens L22 having a concave surface facing the object are cemented in order from the object side. The third lens component E3 comprises a biconvex positive lens L31. The fourth lens component E4 comprises a cemented lens having a positive refractive power in which a negative meniscus lens L41 having a convex surface facing the object and a biconvex positive lens L42 are cemented in order from the object side. The fifth lens component E5 comprises a cemented lens having a negative refractive power in which a biconvex positive lens L51 and a biconcave negative lens L52 are cemented in order from the object side. The image surface I is arranged on the objective optical system side of the fifth lens component E5.

Table 2 described below lists values of data on the scanning optical system according to the second example. The first surface is the pupil conjugate surface P.

TABLE 2
[General Data]

| | | | |
|---|---|---|---|
| f = | 60.005 | Φ = | 6.000 |
| FNO = | 10.001 | Y = | 12.5 |
| TL = | 151.008 | | |

[Lens Data]

| Surface | | | | | |
|---|---|---|---|---|---|
| Number | R | D | νd | nd | θgF |
| 1 | ∞ | 44.918 | | | |
| 2 | −21.949 | 4.000 | 1.49782 | 82.57 | |
| 3 | −24.402 | 1.000 | | | |
| 4 | −92.175 | 10.000 | 1.45600 | 91.37 | |
| 5 | −20.414 | 2.000 | 1.61340 | 44.27 | |
| 6 | −49.625 | 12.400 | | | |
| 7 | 112.878 | 6.000 | 1.59270 | 35.31 | 0.59330 |
| 8 | −100.513 | 3.600 | | | |
| 9 | 132.598 | 2.000 | 1.71999 | 50.27 | |
| 10 | 39.170 | 12.000 | 1.49782 | 82.57 | |
| 11 | −56.922 | 3.700 | | | |
| 12 | 31.222 | 9.346 | 1.49782 | 82.57 | |
| 13 | −76.382 | 4.252 | 1.71700 | 47.97 | |
| 14 | 27.709 | 35.792 | | | |

[Lens Component Data]

| Lens Component | First surface | Focal length |
|---|---|---|
| E1 | 2 | −958.2426 |
| E2 | 4 | 16917.854 |
| E3 | 7 | 90.654 |
| E4 | 9 | 117.667 |
| E5 | 12 | −110.067 |

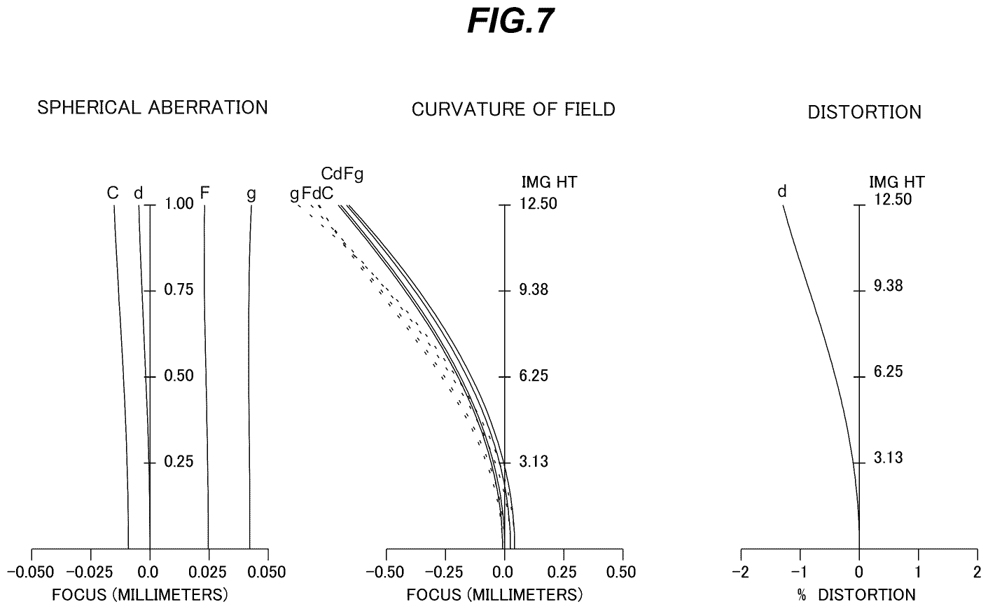

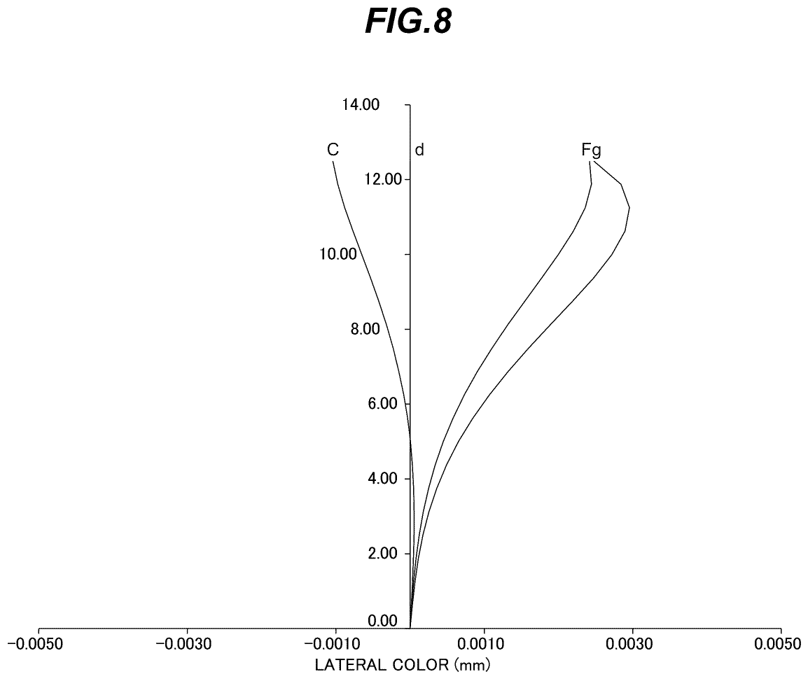

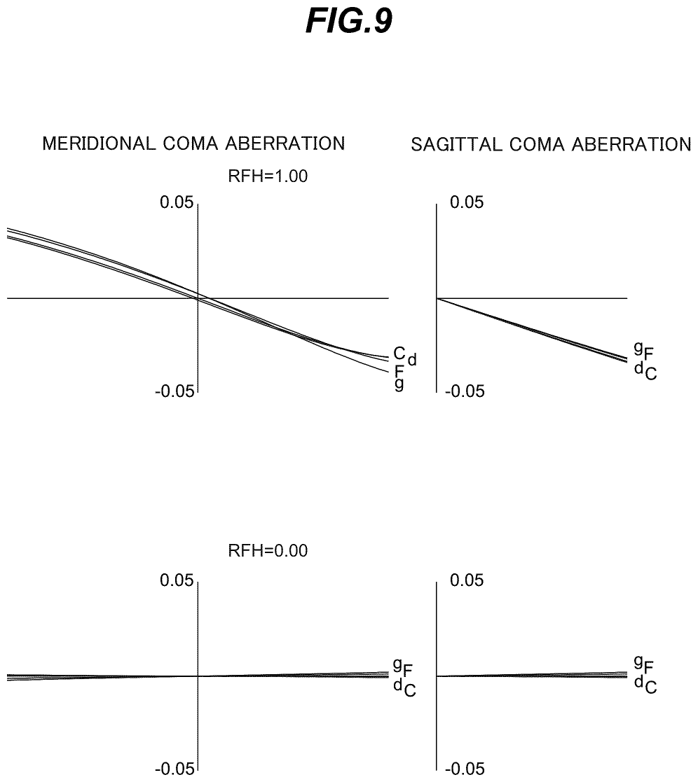

FIG. 7 is a graph showing various aberrations (spherical aberration, curvature of field, and distortion) of the scanning optical system according to the second example. FIG. 8 is a graph showing chromatic aberration of magnification (lateral chromatic aberration) of the scanning optical system according to the second example. FIG. 9 is a graph showing coma aberration (meridional coma aberration and sagittal coma aberration) of the scanning optical system according to the second example. It is found from the aberration graphs that the scanning optical system according to the second example is sufficiently corrected in various aberrations such as curvature of field, and has excellent optical performance.

### Third Example

The third example is described with reference to FIG. 10 to FIG. 13 and Table 3. FIG. 10 is a cross-sectional view illustrating a configuration of a scanning optical system according to the third example. The scanning optical system SL(3) according to the third example comprises a first lens component E1 having a positive refractive power, a second lens component E2 having a negative refractive power, a third lens component E3 having a positive refractive power, a fourth lens component E4 having a positive refractive power, and a fifth lens component E5 having a negative refractive power, arranged in order from the pupil conjugate surface P side along the optical axis.

The first lens component E1 comprises a positive meniscus lens L11 having a concave surface facing the object. The second lens component E2 comprises a cemented lens having a negative refractive power in which a positive meniscus lens L21 having a concave surface facing the object and a negative meniscus lens L22 having a concave surface facing the object are cemented in order from the object side. The third lens component E3 comprises a biconvex positive lens L31. The fourth lens component E4 comprises a cemented lens having a positive refractive power in which a biconvex positive lens L41 and a negative meniscus lens L42 having a concave surface facing the object are cemented in order from the object side. The fifth lens component E5 comprises a cemented lens having a negative refractive power in which a biconvex positive lens L51 and a biconcave negative lens L52 are cemented in order from the object side. The image surface I is arranged on the objective optical system side of the fifth lens component E5.

Table 3 described below lists values of data on the scanning optical system according to the third example. The first surface is the pupil conjugate surface P.

TABLE 3
[General Data]

| | | | |
|---|---|---|---|
| f = | 60.107 | Φ = | 6.000 |
| FNO = | 10.018 | Y = | 12.5 |
| TL = | 151.074 | | |

[Lens Data]

| Surface | | | | | |
|---|---|---|---|---|---|
| Number | R | D | νd | nd | θgF |
| 1 | ∞ | 44.611 | | | |
| 2 | −23.778 | 6.500 | 1.49782 | 82.57 | |
| 3 | −25.845 | 7.682 | | | |
| 4 | −4387.269 | 8.900 | 1.45600 | 91.37 | |
| 5 | −22.184 | 2.000 | 1.61340 | 44.27 | |
| 6 | −161.406 | 6.738 | | | |
| 7 | 113.647 | 7.000 | 1.59270 | 35.31 | 0.59330 |
| 8 | −76.829 | 4.758 | | | |
| 9 | 92.860 | 10.000 | 1.45600 | 91.37 | |
| 10 | −41.084 | 2.000 | 1.71999 | 50.27 | |
| 11 | −55.984 | 2.711 | | | |
| 12 | 32.094 | 10.100 | 1.49782 | 82.57 | |
| 13 | −60.391 | 2.300 | 1.71700 | 47.97 | |
| 14 | 25.452 | 35.774 | | | |

[Lens Component Data]

| Lens Component | First surface | Focal length |
|---|---|---|
| E1 | 2 | 13343.5318 |
| E2 | 4 | −297.000 |
| E3 | 7 | 78.4127 |
| E4 | 9 | 89.701 |
| E5 | 12 | −79.999 |

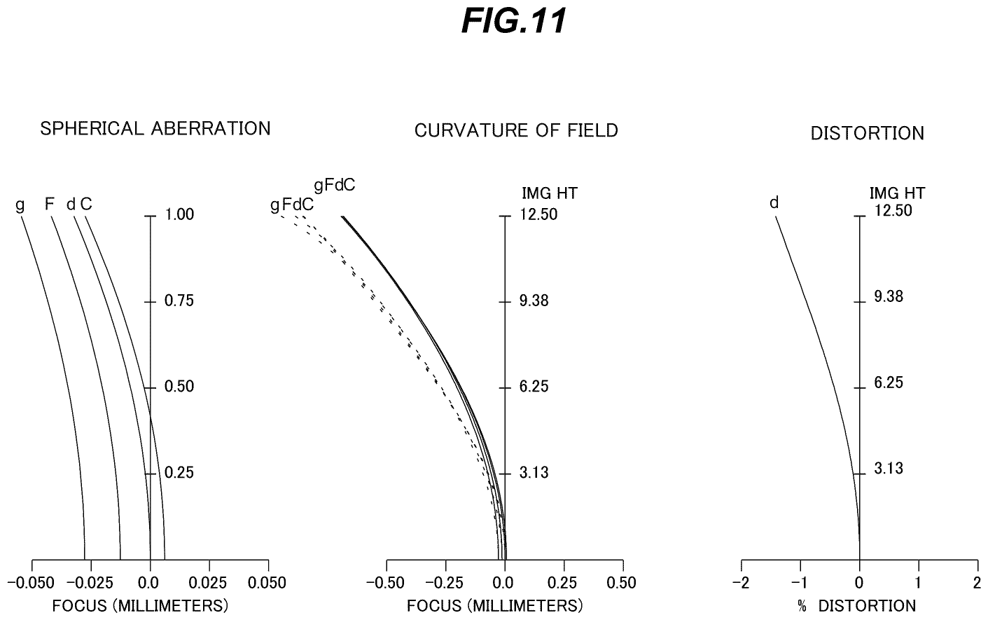

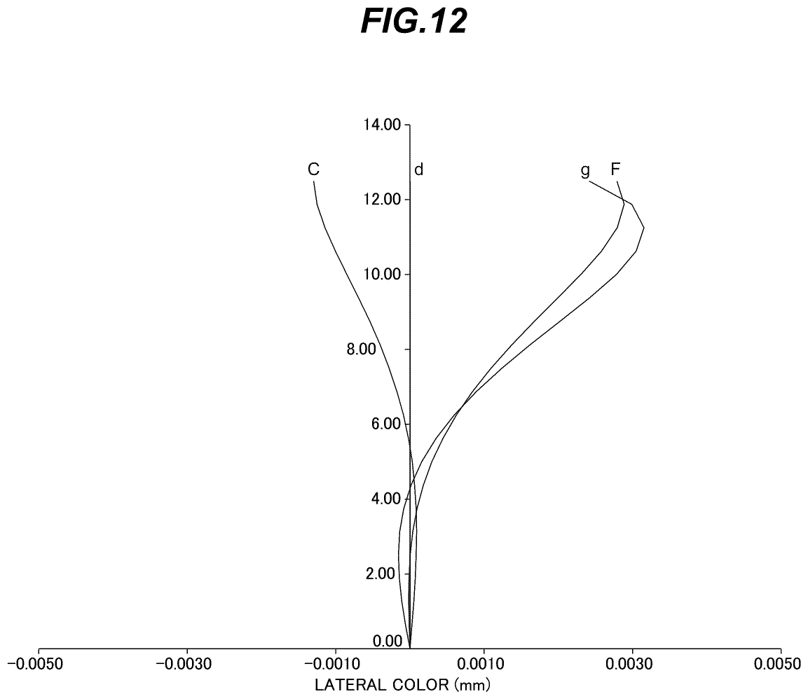

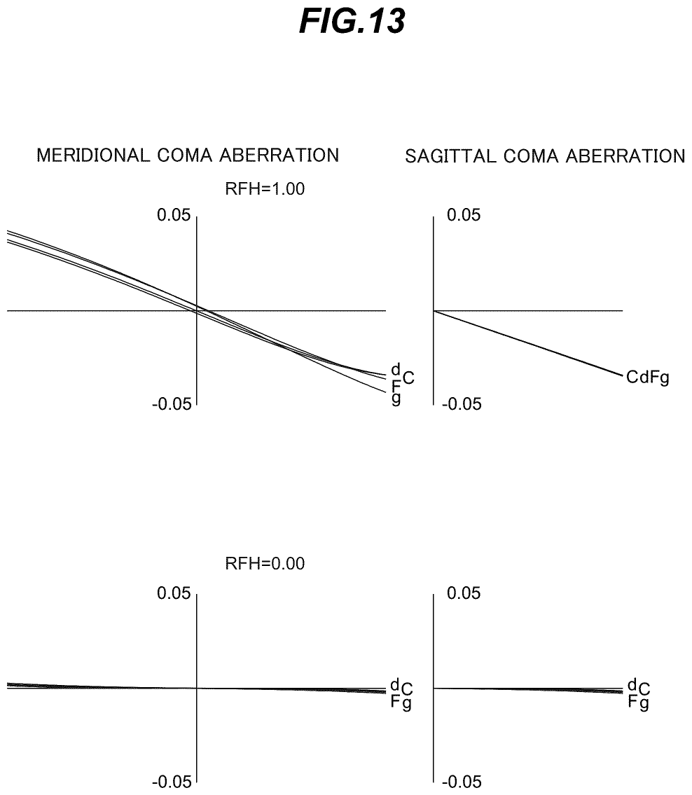

FIG. 11 is a graph showing various aberrations (spherical aberration, curvature of field, and distortion) of the scanning optical system according to the third example. FIG. 12 is a graph showing chromatic aberration of magnification (lateral chromatic aberration) of the scanning optical system according to the third example. FIG. 13 is a graph showing coma aberration (meridional coma aberration and sagittal coma aberration) of the scanning optical system according to the third example. It is found from the aberration graphs that the scanning optical system according to the third example is sufficiently corrected in various aberrations such as curvature of field, and has excellent optical performance.

### Fourth Example

The fourth example is described with reference to FIG. 14 to FIG. 17 and Table 4. FIG. 14 is a cross-sectional view illustrating a configuration of a scanning optical system according to the fourth example. The scanning optical system SL(4) according to the fourth example comprises a first lens component E1 having a negative refractive power, a second lens component E2 having a positive refractive power, a third lens component E3 having a positive refractive power, a fourth lens component E4 having a positive refractive power, and a fifth lens component E5 having a negative refractive power, arranged in order from the pupil conjugate surface P side along the optical axis.

The first lens component E1 comprises a negative meniscus lens L11 having a concave surface facing the object. The second lens component E2 comprises a cemented lens having a positive refractive power in which a biconcave negative lens L21 and a biconvex positive lens L22 are cemented in order from the object side. The third lens component E3 comprises a positive meniscus lens L31 having a convex surface facing the object. The fourth lens component E4 comprises a cemented lens having a positive refractive power in which a biconvex positive lens L41 and a negative meniscus lens L42 having a concave surface facing the object are cemented in order from the object side. The fifth lens component E5 comprises a cemented lens having a negative refractive power in which a biconvex positive lens L51 and a biconcave negative lens L52 are cemented in order from the object side. The image surface I is arranged on the objective optical system side of the fifth lens component E5.

Table 4 described below lists values of data on the scanning optical system according to the fourth example. The first surface is the pupil conjugate surface P.

TABLE 4
[General Data]

| | | | |
|---|---|---|---|
| f = | 60.020 | Φ = | 6.000 |
| FNO = | 10.003 | Y = | 12.5 |
| TL = | 150.899 | | |

[Lens Data]

| Surface | | | | | |
|---|---|---|---|---|---|
| Number | R | D | νd | nd | θgF |
| 1 | ∞ | 45.000 | | | |
| 2 | −25.623 | 4.000 | 1.51680 | 64.13 | |
| 3 | −40.988 | 1.000 | | | |
| 4 | −203.374 | 2.400 | 1.71999 | 50.27 | |
| 5 | 66.170 | 8.700 | 1.43425 | 94.77 | |
| 6 | −33.529 | 9.197 | | | |
| 7 | 35.450 | 5.000 | 1.59270 | 35.31 | 0.59330 |
| 8 | 53.667 | 4.722 | | | |
| 9 | 75.882 | 13.000 | 1.45600 | 91.37 | |
| 10 | −43.186 | 3.000 | 1.68376 | 37.64 | |
| 11 | −62.720 | 4.981 | | | |
| 12 | 48.240 | 12.000 | 1.49782 | 82.57 | |
| 13 | −27.884 | 2.000 | 1.73400 | 51.51 | |
| 14 | 78.861 | 35.899 | | | |

[Lens Component Data]

| Lens Component | First surface | Focal length |
|---|---|---|
| E1 | 2 | −145.127 |
| E2 | 4 | 173.768 |
| E3 | 7 | 159.8651 |
| E4 | 9 | 88.375 |
| E5 | 12 | −167.764 |

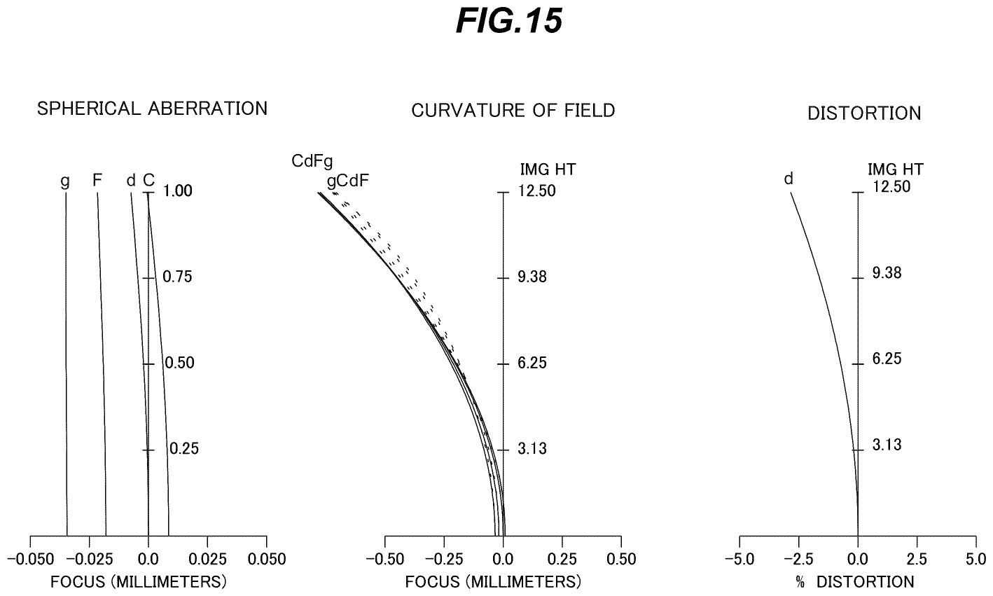

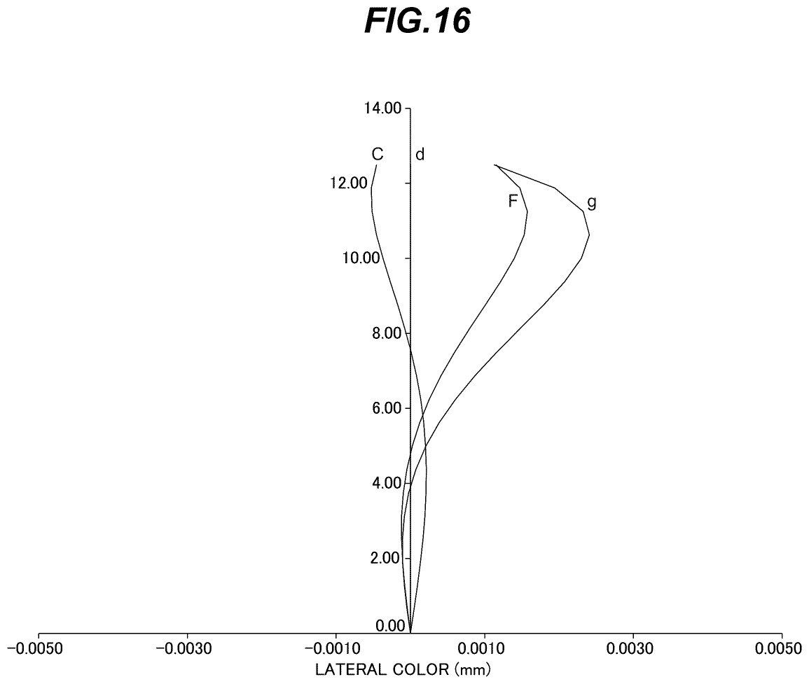

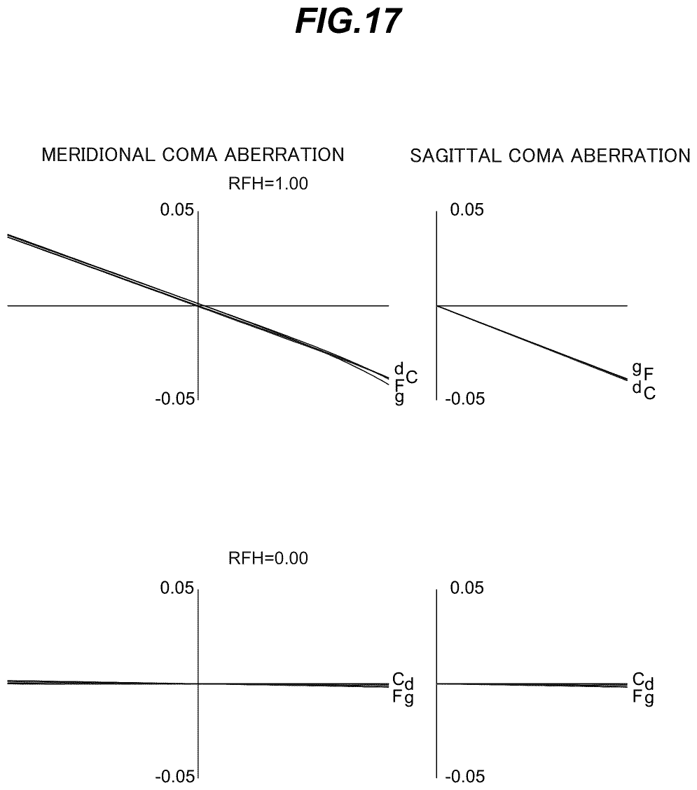

FIG. 15 is a graph showing various aberrations (spherical aberration, curvature of field, and distortion) of the scanning optical system according to the fourth example. FIG. 16 is a graph showing chromatic aberration of magnification (lateral chromatic aberration) of the scanning optical system according to the fourth example. FIG. 17 is a graph showing coma aberration (meridional coma aberration and sagittal coma aberration) of the scanning optical system according to the fourth example. It is found from the aberration graphs that the scanning optical system according to the fourth example is sufficiently corrected in various aberrations such as curvature of field, and has excellent optical performance.

A table of [Conditional Expression Corresponding Value] is illustrated below. The table collectively shows values corresponding to the conditional expressions (1) to (12) for all the examples (first to fourth examples).

$$0.007 < \sum ( nd \times tc / vd ) / LA < 0.021 \qquad Conditional Expression ( 1 )$$

$$- 3 < ( ndA - 1 ) / rA \times f < - 0.6 \qquad Conditional Expression ( 2 )$$

$$0.5 < ( ndE - 1 ) / rE \times f < 3 \qquad Conditional Expression ( 3 )$$

$$vdP < 38 \qquad Conditional Expression ( 4 )$$

$$0.651 < θ gFP + ( 0.001682 \times vdP ) \qquad Conditional Expression ( 5 )$$

$$1 < fP / f < 5 \qquad Conditional Expression ( 6 )$$

$$0.7 < D 0 / f < 1 \qquad Conditional Expression ( 7 )$$

$$0.5 < ( \sum tc ) / LA < 0.9 \qquad Conditional Expression ( 8 )$$

$$0 < D 3 / D 2 < 1 \qquad Conditional Expression ( 9 )$$

$$0.04 < D 2 / TL < 0.11 \qquad Conditional Expression ( 10 )$$

$$0.02 < D 3 / TL < 0.05 \qquad Conditional Expression ( 11 )$$

$$0.000214 < \sum ( nd \times tc / {vd}^{2} ) / LA < 0.000429 \qquad Conditional Expression ( 12 )$$

[Conditional Expression Corresponding Value]

| Conditional | First | Second | Third | Fourth |
|---|---|---|---|---|
| Expression | example | example | example | example |
| (1) | 0.0175 | 0.0168 | 0.0162 | 0.0166 |
| (2) | −1.383 | −1.361 | −1.258 | −1.211 |
| (3) | 1.347 | 1.553 | 1.693 | 0.559 |
| (4) | 35.310 | 35.310 | 35.310 | 35.310 |
| (5) | 0.6527 | 0.6527 | 0.6527 | 0.6527 |
| (6) | 1.620 | 1.511 | 1.305 | 2.664 |
| (7) | 0.750 | 0.749 | 0.742 | 0.750 |
| (8) | 0.714 | 0.706 | 0.690 | 0.716 |
| (9) | 0.430 | 0.290 | 0.706 | 0.513 |
| (10) | 0.079 | 0.082 | 0.045 | 0.061 |
| (11) | 0.034 | 0.024 | 0.031 | 0.031 |
| (12) | 0.0003199 | 0.0003010 | 0.0002915 | 0.0002952 |

According to each of the above-described examples, it is possible to sufficiently correct curvature of field, astigmatism, and chromatic aberration of magnification, and to realize the scanning optical system and the scanning microscope that can obtain a bright image.

Each of the above-described examples is a specific example of the present embodiment, and the present embodiment is not limited to the above-described examples.

In each of the above-described examples, each of the first lens component E1 and the third lens component E3 comprises one lens but is not limited thereto, and may comprise one cemented lens in which a plurality of lenses are cemented with one another. Each of the second lens component E2, the fourth lens component E4, and the fifth lens component E5 comprises one cemented lens in which a plurality of lenses are cemented with one another but is not limited thereto, and may comprise one lens.

### EXPLANATION OF NUMERALS AND CHARACTERS

E1 First lens component
E2 Second lens component
E3 Third lens component
E4 Fourth lens component
E5 Fifth lens component
I Image surface
P Pupil conjugate surface

1. A scanning microscope, comprising:
a scanning mechanism configured to scan a sample with light from a light source;
an objective optical system configured to collect light from the scanning mechanism to the sample; and
a scanning optical system provided between the scanning mechanism and the objective optical system, and configured to guide the light from the scanning mechanism to the objective optical system, wherein
the scanning optical system comprises a plurality of lens components arranged along an optical axis, and has a positive refractive power as a whole,
each of the lens components is one cemented lens in which a plurality of lenses are cemented with one another, or one lens,
a lens surface on the scanning mechanism side of the lens component closest to the scanning mechanism among the plurality of lens components is a concave surface,
a lens surface on the objective optical system side of the lens component closest to the objective optical system among the plurality of lens components is a concave surface, and
the following conditional expression is satisfied:
$$0.007 < \sum ( nd \times tc / vd ) / LA < 0.021 ,$$
where Σ(nd×tc/νd) is: when a refractive index to d-line of each of lenses configuring the plurality of lens components is nd, a center thickness of each of the lenses is tc, and an Abbe number of each of the lenses is νd, a sum of nd×tc/νd of the lenses of the plurality of lens components, and
LA: a distance on the optical axis from the lens surface on the scanning mechanism side of the lens component closest to the scanning mechanism to the lens surface on the objective optical system side of the lens component closest to the objective optical system.

2. The scanning microscope according to claim 1, wherein the following conditional expressions are satisfied:
$$- 3 < ( ndA - 1 ) / rA \times f < - 0 \text{.6} ,$$
$$0.5 < ( ndE - 1 ) / rE \times f < 3 ,$$
where ndA: a refractive index to d-line of a lens closest to the scanning mechanism, among lenses configuring the plurality of lens components,
rA: a radius of curvature of a lens surface on the scanning mechanism side of the lens closest to the scanning mechanism,
ndE: a refractive index to d-line of the lens closest to the objective optical system among the lenses configuring the plurality of lens components,
rE: a radius of curvature of a lens surface on the objective optical system side of the lens closest to the objective optical system, and
f: a focal length of the scanning optical system.

3. The scanning microscope according to claim 1, wherein
a part of the plurality of lens components comprises one positive lens, and
the following conditional expressions are satisfied:
$$vdP < 38 ,$$
$$0.651 < θ gFP + ( 0.001682 \times vdP ) ,$$
where νdP: an Abbe number of the positive lens, and
θgFP: a partial dispersion ratio of the positive lens, and is defined by the following expression when a refractive index to g-line of the positive lens is ngP, a refractive index to F-line of the positive lens is nFP, and a refractive index to C-line of the positive lens is nCP,
$$θ gFP = ( ngP - nFP ) / ( nFP - nCP ) .$$

4. The scanning microscope according to claim 3, wherein the following conditional expression is satisfied:
$$1 < fP / f < 5 ,$$
where fP: a focal length of the positive lens, and
f: a focal length of the scanning optical system.

5. The scanning microscope according to claim 1, wherein the following conditional expression is satisfied:
$$0.7 < D 0 / f < 1 ,$$
where D0: an interval on the optical axis between the scanning mechanism and the lens component closest to the scanning mechanism, and
f: a focal length of the scanning optical system.

6. The scanning microscope according to claim 1, wherein the following conditional expression is satisfied:
$$0.5 < ( \sum tc ) / LA < 0.9 ,$$
where Σtc: a sum of tc of the lenses of the plurality of lens components.

7. The scanning microscope according to claim 1, wherein
the plurality of lens components comprise a first lens component, a second lens component, a third lens component, and a fourth lens component arranged in order from the scanning mechanism side along the optical axis, and
the following conditional expressions are satisfied:
$$0 < D 3 / D 2 < 1 ,$$
$$0.04 < D 2 / TL < 0. 11 ,$$
$$0.02 < D 3 / TL < 0. 05 ,$$
where D2: an air distance on the optical axis between the second lens component and the third lens component,
D3: an air distance on the optical axis between the third lens component and the fourth lens component, and
TL: a distance on the optical axis between a pupil conjugate surface disposed on the scanning mechanism side of the scanning optical system and an image surface disposed on the objective optical system side of the scanning optical system.

8. The scanning microscope according to claim 1, wherein the following conditional expression is satisfied:
$$0.000214 < \sum ( nd \times tc / {vd}^{2} ) / LA < 0.000429 ,$$
where Σ(nd×tc/νd²): a sum of nd×tc/νd² of the lenses of the plurality of lens components.
